(19) United States
(12) Patent Application Publication
(10) Pub. No.: US 2024/0223919 A1
(43) Pub. Date: Jul. 4, 2024

(54) DIGITAL CORRELATED DOUBLE-SAMPLING FOR AN IMAGE SENSOR PIXEL

(71) Applicant: Meta Platforms Technologies, LLC, Menlo Park, CA (US)

(72) Inventors: Song Chen, Redmond, WA (US); Xinqiao Liu, Medina, WA (US); Tsung-Hsun Tsai, Redmond, WA (US); Qing Chao, Redmond, WA (US); Michael Hall, Bellevue, WA (US); David Maurice Moore, Redmond, WA (US); Sharvil Shailesh Talati, Belmont, WA (US)

(21) Appl. No.: 18/531,154

(22) Filed: Dec. 6, 2023

Related U.S. Application Data
(60) Provisional application No. 63/436,406, filed on Dec. 30, 2022.

(51) Int. Cl. H04N 25/616; H04N 25/131; H04N 25/53; H04N 25/67; H04N 25/771

(52) U.S. Cl. CPC H04N 25/616; H04N 25/131; H04N 25/53; H04N 25/67; H04N 25/771

(57) ABSTRACT

Systems and methods of the present disclosure include a digital image sensor pixel configured to perform digital correlated double-sampling (D-CDS) operations to compensate for fixed pattern noise (FPN) induced by comparator propagation delay variation across a digital pixel array. The pixel and D-CDS operations also support quantization of incident light using two pixel memory banks. The pixel includes data retention logic coupled to selectively lock and unlock the output of a comparator. The output of the comparator is combined with memory bank write enable signals to convert photodiode charge into digital pixel values stored in the two memory banks. The digital pixel values stored in the memory banks may be added or subtracted to generate an FPN compensated digital pixel value.

### CROSS-REFERENCE TO RELATED APPLICATIONS

This application claims priority to U.S. provisional Application No. 63/436,406 filed Dec. 30, 2022, which is hereby incorporated by reference.

### TECHNICAL FIELD

This disclosure relates generally to image sensors, and in particular to compensating for noise in an image sensor pixel.

### BACKGROUND INFORMATION

As the use of digital images becomes more prevalent in educational, recreational, and professional endeavors, the quality of images (and videos) has become increasingly important. One characteristic that significantly reduces the quality of digital images is noise. In particular, fixed-pattern noise (FPN) is a type of noise that can generate visual artifacts, such as ghosting, and can be particularly pronounced in low-light conditions. Reducing FPN may improve the quality and usability of digital images.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example diagram of an image sensor that is configured to reduce fixed-pattern noise (FPN), support multiple quantization of incident light values, and provide multi-channel support for visible and non-visible light, in accordance with aspects of the disclosure.

FIG. 2 illustrates a perspective view of an example of a head-mounted device, in accordance with aspects of the disclosure.

FIG. 3 illustrates an imaging system including an image pixel array, in accordance with aspects of the disclosure.

FIGS. 4A, 4B, 4C, and 4D illustrate diagrams of various components of a pixel cell, in accordance with aspects of the disclosure.

FIG. 5 illustrates a diagram of a quantity of charge accumulated with respect to time for different light intensity ranges, in accordance with aspects of the disclosure.

FIG. 6A illustrates a timing diagram of an example of time-to-saturation measurement by an ADC, in accordance with aspects of the disclosure.

FIG. 6B illustrates a timing diagram of an example of measurement of a quantity of charge stored at charge storage device, in accordance with aspects of the disclosure.

FIG. 7 illustrates an example timing diagram of sequences of control signals of pixel cell for performing digital double-correlated sampling (D-CDS) operations with triple quantization, in accordance with aspects of the disclosure.

FIG. 8 illustrates an example of a process for D-CDS in an image sensor pixel with triple quantization, in accordance with aspects of the disclosure.

FIG. 9 illustrates an example of a process for quantization mode independent fixed-pattern noise (FPN) correction for an image sensor pixel, in accordance with aspects of the disclosure.

FIG. 10 illustrates a timing diagram of an example sequence of control signals that can be generated to perform high dynamic range (HDR) operations that include multiple quantization of incident light values for a pixel, in accordance with aspects of the disclosure.

FIG. 11 illustrates a timing diagram that includes an example sequence of control signals that can be generated to perform multiple exposure HDR operations for a pixel, in accordance with aspects of the disclosure.

FIG. 12 illustrates an example diagram of a pixel having a superpixel structure configured to provide dual-channel imaging, in accordance with aspects of the disclosure.

FIG. 13 illustrates an example diagram of dual-channel exposure time control, in accordance with aspects of the disclosure.

FIG. 14 illustrates an example diagram of enhanced and removed NIR features for pixel maps from multi-channel pixels, in accordance with aspects of the disclosure.

FIG. 15 illustrates an example of a process for operating memory banks in quantization operations for a digital image sensor pixel, in accordance with aspects of the disclosure.

FIG. 16 illustrates an example of a process for performing D-CDS operations in an image sensor pixel, in accordance with aspects of the disclosure.

### DETAILED DESCRIPTION

Embodiments of methods and systems for digital correlated double-sampling for an image sensor pixel are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.4 μm.

In aspects of this disclosure, the term “transparent” may be defined as having greater than 90% transmission of light. In some aspects, the term “transparent” may be defined as a material having greater than 90% transmission of visible light.

A digital pixel sensor (DPS) that uses analog correlated double-sampling (A-CDS) can have relatively high remaining fixed-pattern noise (FPN). A-CDS can help reduce the FPN contributed by comparator input offset through auto-zeroing, but A-CDS does not appear to reduce the FPN induced by comparator propagation delay variation across a digital pixel array.

Digital correlated double-sampling (D-CDS) can solve this remaining FPN issue in a DPS. However, D-CDS includes running an analog-to-digital converter (ADC) twice, and the two digital codes from D-CDS both contain the comparator input offset and comparator propagation delay. Subtracting the two digital codes will cancel these noise components and result in much less FPN, as compared to A-CDS. A DPS with D-CDS, as disclosed, includes two banks of memory inside each pixel to store ADC reads.

In addition to providing D-CDS operations, the disclosed DPS supports a triple quantization scheme configured to achieve high dynamic range (HDR) readout performance. The disclosed DPS is configured to combine triple quantization and D-CDS, in addition to supporting pixel operation timing for other types of multiple quantization schemes for HDR, in accordance with various embodiments.

Systems and methods of the present disclosure include a digital image sensor pixel configured to perform D-CDS operations to compensate for FPN induced by comparator propagation delay variation across a digital pixel array. The pixel and D-CDS operations also support quantization of incident light using two pixel memory banks. The pixel includes a photodiode, a charge sensing unit, and an ADC that includes two memory banks. The photodiode produces charge in response to incident light intensity. The charge storage unit couples the photodiode to the ADC to convert photodiode charge into digital pixel values that are stored in the memory banks.

The ADC may include a comparator and data retention logic. The data retention logic may be configured to selectively lock and unlock the output of the comparator. In D-CDS operations, the data retention logic locks both of the two banks of memories while the two banks are involved in two separate quantization operations. The output of the comparator may be combined with memory bank write enable signals to convert photodiode charge into digital pixel values stored in the two memory banks. The digital pixel values stored in the memory banks may be combined (e.g., added together or subtracted from each other) to generate an FPN compensated digital pixel value.

The pixel may include a photosensitive region that is a superpixel. The superpixel may include a 2×2 array or matrix of subpixels that are configured to co-locate image data across multiple (e.g., two) channels. A first channel may include a monochromatic bandwidth that includes visible spectrum light and near-infrared (NIR) spectrum light. A second channel may be bandpass filters to include a band of NIR spectrum light. Two monochromatic subpixels may be positioned diagonally and be unfiltered. Two NIR subpixels may be positioned diagonally and may be bandpass filtered to be response to NIR light. A controller may be configured to perform operations on the image data from the two channel to suppress or enhance the NIR light data. A controller may provide signals to the pixel or selectively alter (e.g., extend or shorten) the exposure time of one or both of the channels of light, according to various embodiments of the disclosure.

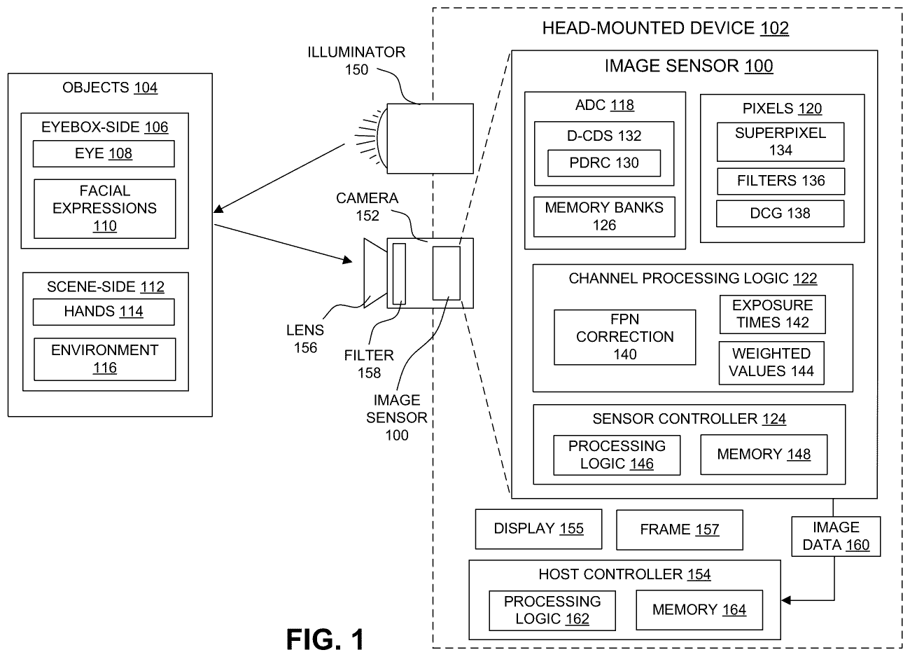

The apparatus, system, and method for D-CDS for an image sensor pixel that are described in this disclosure include improvements in the quality of digital images that may be used for object tracking or eye tracking systems in a head-mounted device. These and other embodiments are described in more detail in connection with FIGS. 1-16.

FIG. 1 illustrates an example diagram of an image sensor 100 that is configured to reduce fixed-pattern noise (FPN) and provide multi-channel support for visible and non-visible light, in accordance with aspects of the disclosure. Image sensor 100 may be one of a number of components included to support operation of a head-mounted device 102, according to an embodiment. Head-mounted device 102 may be configured to use image sensor 100 to image one or more objects 104, according to an embodiment. Objects 104 may include eyebox-side objects 106 (e.g., an eye 108, facial expressions 110, etc.) and/or scene-side objects 112 (e.g., hands 114, objects in an environment 116, etc.). A head-mounted device, such as head-mounted device 102, is one type of smart device. In some contexts, head-mounted device 102 is also a head-mounted display (HMD) that is configured to provide artificial reality. Artificial reality is a form of reality that has been adjusted in some manner before presentation to the user, which may include, e.g., virtual reality (VR), augmented reality (AR), mixed reality (MR), hybrid reality, or some combination and/or derivative thereof.

Image sensor 100 may include an analog-to-digital converter (ADC) 118, pixels 120, channel processing logic 122, and a sensor controller 124 to reduce FPN and provide multi-channel support for visible and non-visible light, in accordance with aspects of the disclosure. ADC 118 converts analog voltage values within pixels 120 into digital values, and the digital values are stored in one or more memory banks 126, according to an embodiment. At least some of the digital values represent incident light intensity values of a pixel photodiode. ADC 118 may be included in one or more of pixels 120 to reduce ADC latencies, according to an embodiment. ADC 118 may include a pixel data retention control cell (PDRC) 130 that operates together with various electronics components (e.g., a comparator, latches, switches, etc.) to enable D-CDS operations 132 of charge within a pixel, according to an embodiment. Pixels 120 and ADC 118 may be configured to quantize incident light intensity values into multiple quantization states (e.g., low light, medium light, and high light), and ADC 118 may be operated by sensor controller 124 to perform D-CDS operations 132 with multiple quantization of incident light intensity values, according to an embodiment. Performing D-CDS operations 132 to read pixels 120 reduces or cancels FPN from digital pixel values.

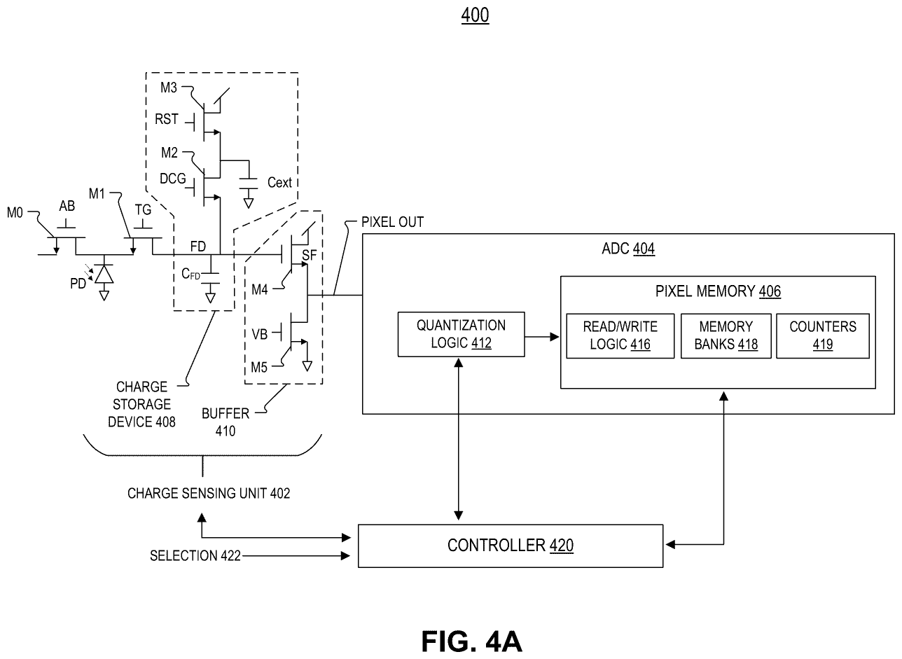

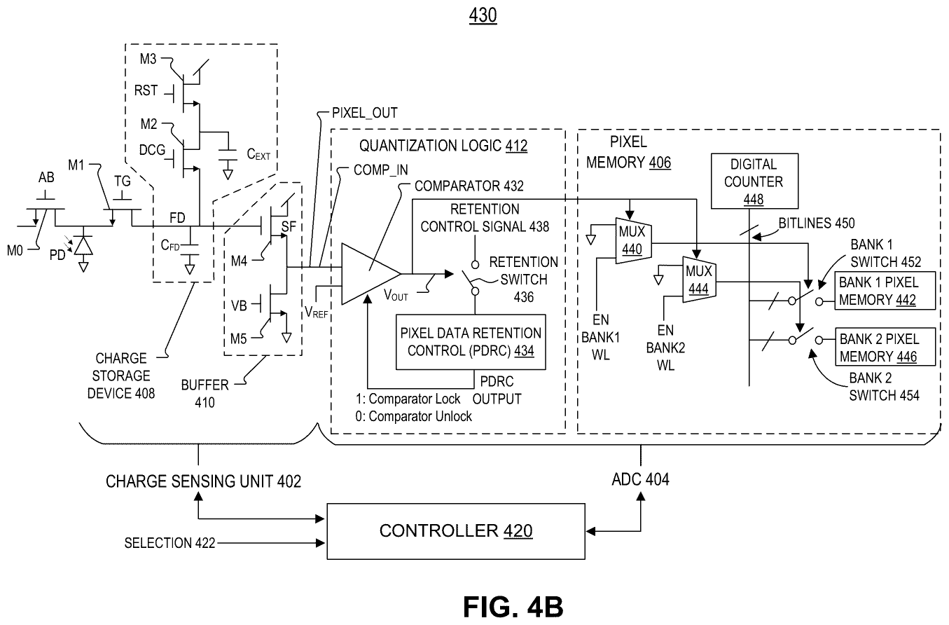

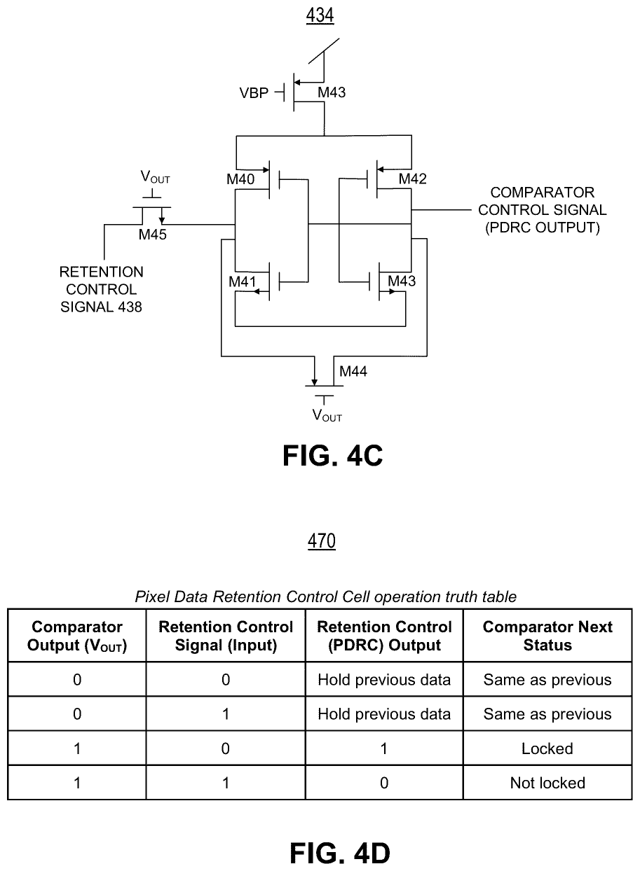

Each of pixels 120 is configured to convert photons to an electrical signal (e.g., analog voltage, digital value), in accordance with aspects of the disclosure. Each of pixels 120 may include a shutter switch, a photodiode, a transfer gate, a floating diffusion (FD), a reset switch, a dual conversion gain (DCG) switch, a low conversion gain capacitor, a source follower, and a current source (e.g., a biased transistor). Some of these components are illustrated in, for example, FIGS. 4A, 4B, and 4C, and are described below.

A typical pixel in an image sensor includes a photodiode to sense incident light by converting photons into charge (e.g., electrons or holes). The incident light can include components of different wavelength ranges for different applications, such as 2D and 3D sensing. Moreover, to reduce image distortion, a global shutter operation can be performed in which each photodiode of the array of photodiodes senses the incident light simultaneously in a global exposure period to generate the charge. The charge can be converted by a charge sensing unit (e.g., a floating diffusion) to convert charge to a voltage. An array of pixel cells can measure different components of the incident light based on the voltages converted by the charge sensing unit and provide the measurement results for generation of 2D and 3D images of a scene.

One or more of pixels 120 may also include a superpixel 134, filters 136, and DCG circuitry 138 to enable dual-channel readout of visible and non-visible light and conversion gain adjustments, in accordance with aspects of the disclosure. Superpixel 134 may include two or more subpixels that share a transfer gate, DCG circuitry 138, ADC 118, and/or other pixel readout circuitry. Superpixel 134 may include a 2×2 array of subpixels. The 2×2 array of subpixels may include two monochrome (M) pixels positioned diagonal from each other and may include two near-infrared (NIR) pixels positioned diagonal from each other. Superpixel 134 may be configured to provide pixel-level co-location of image data using multiple (e.g., dual) channels. Filters 136 may include NIR filters strategically positioned in the color filter array (CFA) over the NIR subpixels in superpixel 134. The NIR filters may be configured to pass NIR bands (e.g., 850 nm+/−20 nm, 950 nm+/−20 nm) and block light having wavelengths in the visible light spectrum. Pixels 120 may include DCG circuitry 138 that selectively increase/decrease the conversion gain of the photodiode readout to support high dynamic range (HDR) operations/images. DCG circuitry 138 may also be configured to enable triple quantization of incident light intensity values, according to an embodiment.

Channel processing logic 122 may be configured to perform a number of operations on image data from pixels 120, in accordance with aspects of the disclosure. Channel processing logic 122 may be implemented as an image sensor controller (or sub-controller) or may be integrated into a controller for head-mounted device 102. Some of the operations that may be performed by channel processing logic 122 include post-processing FPN correction 140, providing channel-specific exposure times 142, and providing weighted values 144 for each superpixel channel (e.g., the NIR channel and the monochromatic channel) to emphasize and/or suppress NIR image data from monochrome image data, according to an embodiment. Channel processing logic 122 may at least partially be integrated into processing logic 146 of sensor controller 124, according to an embodiment.

Sensor controller 124 is configured to provide various control signals to operate ADC 118 and pixels 120, in accordance with aspects of the disclosure. Example control signals may include shutter controls, pixel transfer gate (TG) signals, pixel reset signals, DCG signals, ADC ramp signals, and memory control signals (e.g., for memory banks 126). Sensor controller 124 may also be configured to read digital pixel intensity values (e.g., image data) from memory banks 126. Sensor controller 124 may include processing logic 146 and memory 148. Sensor controller 124 may be configured to provide control signals for quantizing pixel intensity values and perform noise reduction (e.g., D-CDS operations 132), for example.

Head-mounted device 102 may be a device that is worn about the head of a user and may be configured to provide one or more forms of artificial reality (e.g., AR, VR, MR) experiences to a user. Head-mounted device 102 may include an illuminator 150, a camera 152, and a host controller 154, in accordance with aspects of the disclosure. Illuminator 150 may be carried by a frame 157 of head-mounted device 102 and may be oriented to illuminate one or more objects 104. Illuminator 150 may be pulsed or otherwise selectively operated (e.g., in low-light conditions) to facilitate imaging objects 104, according to an embodiment. Illuminator 150 may be implemented as one or more of light emitting diodes (LEDs), photonic integrated circuit (PIC) based illuminators, micro light emitting diode (micro-LED), an edge emitting LED, a superluminescent diode (SLED), a vertical cavity surface emitting laser (VCSEL), or another type of laser. Illuminator 150 may be configured to emit light in the infrared or NIR bands (e.g., 850 nm, 950 nm, etc.).

Camera 152 may be configured to capture images of objects 104 and may include a lens 156, a filter 158, and image sensor 100. Lens 156 may include one or more optical elements configured to focus light onto image sensor 100. Filter 158 may include a bandpass filter configured to pass the visible light spectrum and a portion of the infrared or NIR spectrum of light, according to an embodiment. Although a single camera 152 is illustrated, head-mounted device 102 may include a number of cameras oriented away from the user and may include a number of cameras oriented towards the user (e.g., towards the eyebox region) to support object identification, environment recording, facial expression recognition, and/or eye tracking, according to various embodiments.

Host controller 154 may be communicatively coupled to illuminator 150, camera 152, and a display 155. Host controller 154 may be configured to selectively operate illuminator 150 to illuminate one or more of objects 104. Host controller 154 communicates with camera 152 to receive image data 160, according to an embodiment. Host controller 154 may include processing logic 162 and memory 164. Processing logic 162 and memory 164 may be configured to update one or more user interface elements provided in display 155 to provide an immersive artificial reality experience that is at least partially based on image data 160, according to an embodiment. Processing logic 162 may include object identification logic and/or eye tracking logic and may be configured to provide information (e.g., user experience buttons, text, graphics, and/or other elements) to display 155 based on characteristics of one or more objects 104. Processing logic 162 may include circuitry, logic, instructions stored in a machine-readable storage medium, ASIC circuitry, FPGA circuitry, and/or one or more processors. Processing logic 162 may be coupled to memory 164 (e.g., volatile and/or non-volatile) to perform one or more (computer-readable) instructions stored on memory 164.

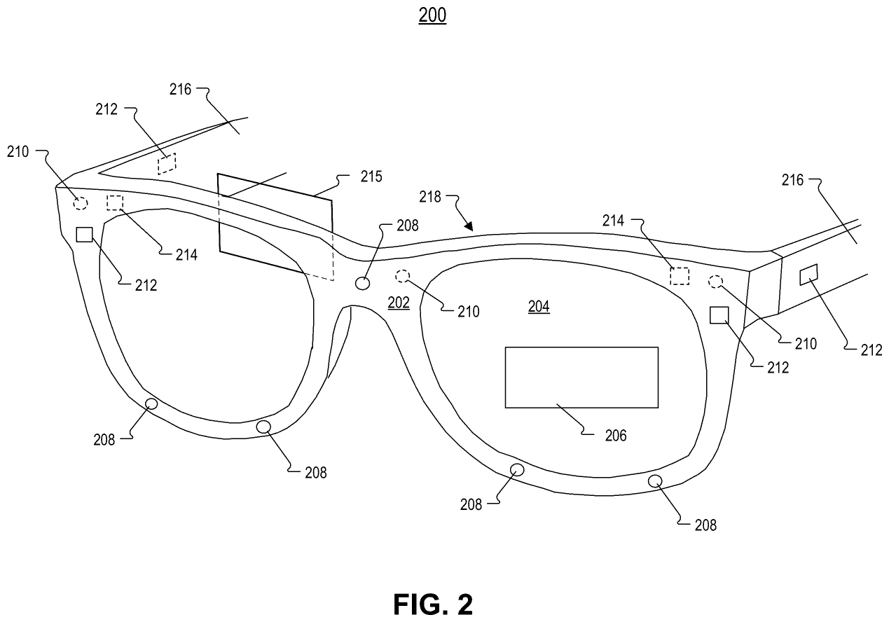

FIG. 2 illustrates a perspective view of an example of a head-mounted device 200, in accordance with aspects of the disclosure. Head-mounted device 200 is an example implementation of head-mounted device 102 (shown in FIG. 1). Head-mounted device 200 may include a frame 202, a lens assembly 204, and a display 206, in accordance with aspects of the disclosure. Head-mounted device 200 also includes a number of outward facing illuminators 208, a number of inward facing illuminators 210, a number of outward facing cameras 212, and a number of inward facing cameras 214, according to an embodiment. Inward facing is a reference of frame 202 that is user-facing or facing eyebox region 215. Outward facing is a reference of frame 202 that is facing away from the user (e.g., forward and/or sideways facing). Illuminators 208 and 210 are example implementations of illuminator 150 (shown in FIG. 1), and cameras 212 and 214 are example implementations of camera 152 (shown in FIG. 1), in accordance with aspects of the disclosure. Illuminators 208 and 210 and cameras 212 and 214 may be positioned at various locations of frame 202, such as on an arm 216 or on a lens-carrying portion 218 of frame 202. For example, illuminators 208 and 210 and/or cameras 212 and 214 may be incorporated into arm 216 and/or into the top, side, middle, or bottom of lens-carrying portion 218. One or more of the illuminators and/or cameras may be at least partially integrated into lens assembly 204, according to an embodiment. Display 206 may be integrated into or positioned onto lens assembly 204. Display 206 may be integrated into a display layer of a stack of optical layers that define lens assembly 204. Display 206 may include a waveguide, a projector (e.g., integrated into the frame), a liquid crystal display (LCD), an organic light emitting diode (OLED) display, or a micro-LED display, according to various embodiments.

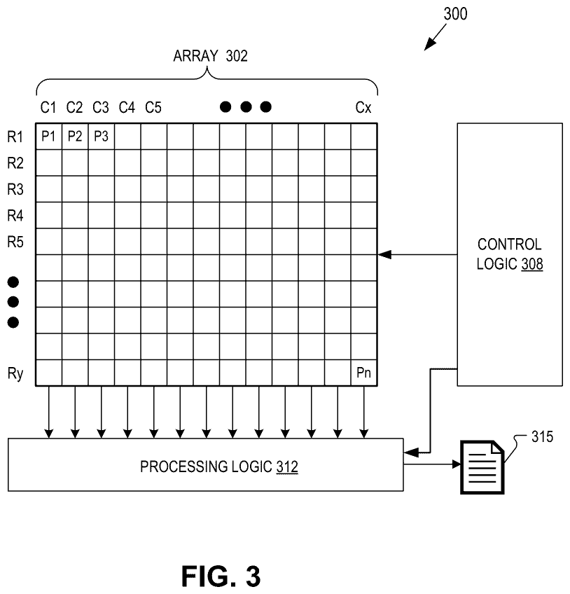

FIG. 3 illustrates an imaging system 300 including an image pixel array 302, in accordance with aspects of the disclosure. All or portions of imaging system 300 may be included in an image sensor, such as image sensor 100 (shown in FIG. 1), in some implementations. Imaging system 300 includes control logic 308, processing logic 312, and image pixel array 302. Image pixel array 302 may be arranged in rows and columns where integer y is the number of rows and integer x is the number of columns. The image pixel array 302 may have a total of n pixels (P) and integer n may be the product of integer x and integer y. In some implementations, n is over one million imaging pixels. Each imaging pixel may be a superpixel that includes several subpixels, in accordance with aspects of the disclosure.

In operation, control logic 308 drives image pixel array 302 to capture an image. Image pixel array 302 may be configured to have a global shutter or a rolling shutter, for example. Each subpixel may be configured in a 3-transistor (3T), 4-transistor (4T), or 5-transistor (5T) readout circuit configuration. Processing logic 312 is configured to receive the imaging signals from each subpixel. Processing logic 312 may perform further operations such as subtracting or adding some imaging signals from other imaging signals to generate image data 315. Aspects of a superpixel, in accordance with this disclosure, may be disposed over image pixel array 302 in imaging system 300. Aspects of noise reduction and channel processing, in accordance with this disclosure, may be integrated into imaging system 300.

Reference is now made to FIGS. 4A, 4B, 4C, and 4D, which illustrate components of a pixel cell, in accordance with aspects of the disclosure. FIG. 4A illustrates a pixel cell 400 that includes a charge sensing unit 402 and an ADC 404, according to an embodiment. Charge sensing unit 402 can include a photodiode PD, a shutter switch M0, a transfer switch M1, a charge storage device 408, and a buffer 410. ADC 404 may include quantization logic 412 and pixel memory 406. Quantization logic 412 may be used for quantizing pixel intensity values into low, medium, and high intensity light levels. Quantization logic 412 may be configured to selectively lock pixel memory 406 during quantization operations. Quantization logic 412 may be coupled to pixel memory 406, and pixel memory 406 can be internal to or external to pixel cell 400. Pixel memory 406 may include read/write (WR) logic 416, memory banks 418, and counters 419.

Pixel cell 400 further includes a controller 420 to control the switches, charge sensing unit 402, and ADC 404. Controller 420 can control charge sensing unit 402 and ADC 404 to perform multiple quantization operations associated with different light intensity ranges to generate a digital representation of the intensity of the incident light. Controller 420 can receive a selection signal 422 to select which of the multiple quantization operations to be performed (and which are to be skipped). Selection signal 422 can come from a host device (e.g., head-mounted device) which hosts an application that uses the digital pixel values of incident light intensity. ADC 404 may be configured to determine which quantization operation output is to be stored in pixel memory 406 and/or to be output as a pixel value. Controller 420 can be internal to pixel cell 400 or can be part of a host controller (e.g., host controller 154, shown in FIG. 1). Each switch can be a transistor such as, for example, a metal-oxide-semiconductor field-effect transistor (MOSFET), a bipolar junction transistor (BJT), etc.

Controller 420 controls charge sensing unit 402 to enable reading and quantizing digital pixel values, in accordance with aspects of the disclosure. Controller 420 selectively disables shutter switch M0 with an AB signal to start an exposure period, during which photodiode PD can generate and accumulate charge in response to incident light. Controller 420 provides a TG signal to control transfer switch M1 to transfer some of the charge from photodiode PD to charge storage device 408. In one quantization operation, transfer switch M1 can be biased at a partially-on state to set a quantum well capacity of photodiode PD, which also sets a quantity of charge stored at the photodiode PD. After photodiode PD is saturated by the charge (e.g., residual charge), overflow charge can flow through transfer switch M1 to charge storage device 408. In another quantization operation, transfer switch M1 can be fully turned on to transfer the residual charge from photodiode PD to charge storage device 408 for measurement.

Charge storage device 408 has a configurable capacity and can convert the charge transferred from transfer switch M1 to a voltage at a node FD (floating diffusion). Charge storage device 408 includes an FD capacitor C_{FD} (e.g., a MOSFET configured as a capacitor) and an extension capacitor C_{ENT} (e.g., a MOSFET configured as a capacitor, a poly-poly capacitor, etc.) that are coupled together by a DCG switch M2. DCG switch M2 can be selectively enabled by a DCG signal to expand the capacity of charge storage device 408 by coupling capacitor C_{FD} with capacitor C_{EXT} in parallel. DCG switch M2 may also be selectively disabled to reduce the capacity of charge storage device 408 by de-coupling capacitors C_{FD} and C_{EXT} from each other. The capacity of charge storage device 408 can be reduced for measurement of residual charge to increase the charge-to-voltage gain (or “conversion gain”) and to reduce the quantization error. Moreover, the capacity of charge storage device 408 can also be increased for measurement of overflow charge to reduce the likelihood of saturation and to improve non-linearity of charge sensing unit 402. As described below, the capacity of charge storage device 408 can be adjusted for measurement of different incident light intensity ranges for photodiode PD. Charge storage device 408 also includes a reset switch M3, which can be controlled by an RST signal that may be provided by controller 420 to reset capacitors C_{FD} and C_{EXT} between different quantization operations.

Buffer 410 couples charge from the photodiode PD to ADC 404 for conversion to a digital pixel value. Buffer 410 can include a source follower (SF) switch M4 configured as a source follower to buffer the voltage at node FD to improve driving strength. The buffered voltage can be output to a node PIXEL_OUT for ADC 404. SF switch M4 can be biased by a current source switch M5 that is operated by a voltage bias (VB) signal from controller 420, according to an embodiment.

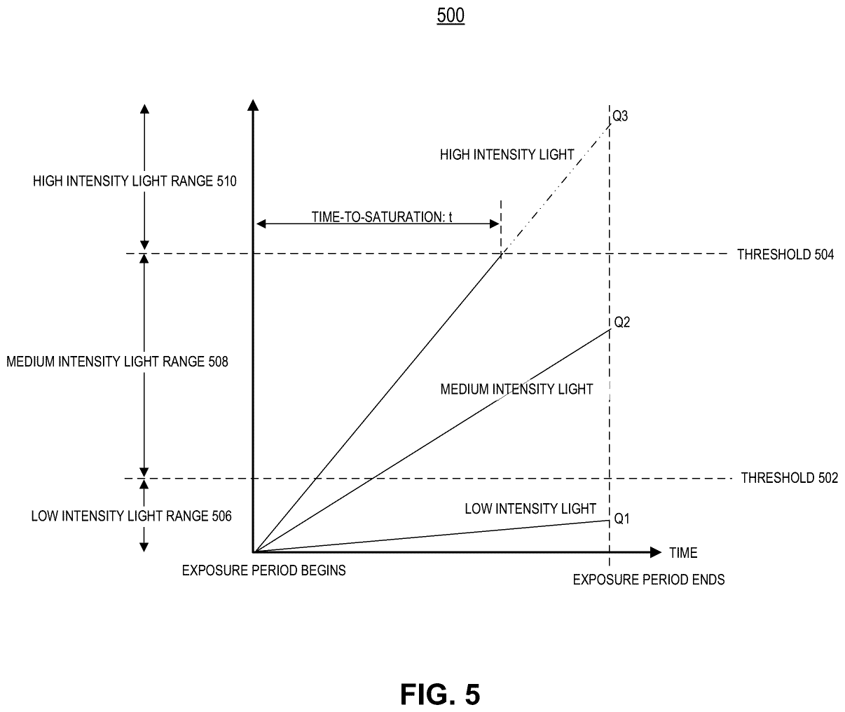

As described above, charge generated by photodiode PD within an exposure period can be temporarily stored in charge storage device 408 and converted to a voltage. The voltage can be quantized to represent an intensity of the incident light based on a pre-determined relationship between the charge and the incident light intensity. Reference is now made to FIG. 5, which illustrates a diagram 500 of a quantity of charge accumulated with respect to time for different light intensity ranges. The total quantity of charge accumulated at a particular time point can reflect the intensity of light incident upon photodiode PD (e.g., shown in FIG. 4A and FIG. 4B) within an exposure period. The quantity of charge can be measured when the exposure period ends, for example. A threshold 502 and a threshold 504 can be defined for a threshold quantity of charge defining a low light intensity range 506, a medium light intensity range 508, and a high light intensity range 510 for the intensity of the incident light. For example, if the total accumulated charge is below threshold 502 (e.g., Q1), the incident light intensity is within low light intensity range 506. If the total accumulated charge is between threshold 504 and threshold 502 (e.g., Q2), the incident light intensity is within medium light intensity range 508. If the total accumulated charge is above threshold 504, the incident light intensity is within medium light intensity range 510. The quantity of the accumulated charge, for low and medium light intensity ranges, can correlate with the intensity of the incident light, if the photodiode does not saturate within the entire low light intensity range 506 and the measurement capacitor does not saturate within the entire medium light intensity range 508.

The definitions of low light intensity range 506 and medium light intensity range 508, as well as thresholds 502 and 504, can be based on the full well capacity of photodiode PD and the capacity of charge storage device 408. For example, low light intensity range 506 can be defined such that the total quantity of residual charge stored in photodiode PD, at the end of the exposure period, is below or equal to the storage capacity of the photodiode PD, and threshold 502 can be based on the full well capacity of photodiode PD. Moreover, medium light intensity range 508 can be defined such that the total quantity of charge stored in charge storage device 408, at the end of the exposure period, is below or equal to the storage capacity of capacitor C_{FD}. Threshold 504 can be based on the storage capacity of charge storage device 408. Threshold 504 can be based on a scaled storage capacity of charge storage device 408 to ensure that when the quantity of charge stored in charge storage device 408 is measured for intensity determination, capacitor C_{FD} does not saturate, and the measured quantity also relates to the incident light intensity. As described below, thresholds 502 and 504 can be used to detect whether photodiode PD and charge storage device 408 saturate, which can determine the intensity range of the incident light.

In a case where the incident light intensity is within high light intensity range 510, the total overflow charge accumulated at charge storage device 408 may exceed threshold 504 before the exposure period ends. As additional charge is accumulated, charge storage device 408 may reach full capacity before the end of the exposure period, and charge leakage may occur. To avoid measurement error caused due to charge storage device 408 reaching full capacity, a time-to-saturation (TTS) measurement can be performed to measure the time duration it takes for the total overflow charge accumulated at charge storage device 408 to reach threshold 504. A rate of charge accumulation at charge storage device 408 can be determined based on a ratio between threshold 504 and the time-to-saturation, and a hypothetical quantity of charge (Q3) that could have been accumulated at charge storage device 408 at the end of the exposure period (if the capacitor had limitless capacity) can be determined by extrapolation according to the rate of charge accumulation. The hypothetical quantity of charge (Q3) can provide a reasonably accurate representation of the incident light intensity within high light intensity range 510.

Referring back to FIG. 4A, to measure high light intensity range 510 and medium light intensity range 508, transfer switch M1 can be biased by TG signal in a partially turned-on state. For example, the gate voltage of transfer switch M1 (TG) can be set based on a target voltage developed at photodiode PD corresponding to the full well capacity of photodiode PD. With such arrangements, overflow charge (e.g., charge generated by the photodiode after the photodiode saturates) will transfer through transfer switch M1 to reach charge storage device 408, to measure time-to-saturation (for high light intensity range 510) and/or the quantity of charge stored in charge storage device 408 (for medium light intensity range 508). For measurement of medium and high light intensity ranges, the capacitance of charge storage device 408 (by coupling capacitors C_{EXT} and C_{FD} together) can also be configured to increase threshold 504.

Moreover, to measure low light intensity range 506, transfer switch M1 can be controlled in a fully turned-on state to transfer the residual charge stored in photodiode PD to charge storage device 408. The transfer can occur after the quantization operation of the overflow charge stored at charge storage device 408 completes and after charge storage device 408 is reset. Moreover, the capacitance of charge storage device 408 can be reduced. As described above, the reduction in the capacitance of charge storage device 408 can increase the charge-to-voltage conversion ratio/gain at charge storage device 408, such that a higher voltage can be developed for a certain quantity of stored charge. The higher charge-to-voltage conversion ratio can reduce the effect of measurement errors (e.g., quantization error, comparator offset, etc.) on the accuracy of low light intensity determination (which may be introduced by subsequent quantization operations). The measurement error can set a limit on a minimum voltage difference that can be detected and/or differentiated by the quantization operation. By increasing the charge-to-voltage conversion ratio, the quantity of charge corresponding to the minimum voltage difference can be reduced, which in turn reduces the lower limit of a measurable light intensity by pixel cell 400 and extends the dynamic range.

The charge (residual charge and/or overflow charge) accumulated at charge storage device 408 can develop an analog voltage at node FD, which can be buffered by buffer 410 at node PIXEL_OUT and digitized by ADC 404. As shown in FIG. 4A, ADC 404 includes or is coupled to pixel memory 406. ADC 404 includes quantization logic 412, and pixel memory 406 includes read/write logic 416 and memory banks 418, according to an embodiment. Quantization logic 412 may include a number of components configured to: determine saturation characteristics (e.g., TTS) of a pixel, categorize a light intensity value of incident light, and convert the light intensity value to a digital value. ADC 404 and quantization logic 412 may receive a number of control signals from controller 420. ADC 404 and quantization logic 412 may include comparators, switches, inverters, and data retention logic (e.g., PDRC 130, shown in FIG. 1) to convert charge from photodiode PD into a digital value stored in pixel memory 406.

Pixel memory 406 may receive one or more control signals from ADC 404 to support conversion of photodiode PD charge into a digital value, according to an embodiment. In one implementation, at least part of pixel memory 406 is included in ADC 404 (e.g., read/write logic 416). Pixel memory 406 includes read/write logic 416 and memory banks 418. Read/write logic 416 may be configured to receive control signals from quantization logic 412 and controller 420 to capture, for example, a digital representation of a light intensity value. Read/write logic 416 may be configured to use control signals to write a value provided by one or more counters 419 to convert a voltage at node PIXEL_OUT to a digital value that may be read and/or used by controller 420, according to an embodiment.

FIG. 4B illustrates a pixel 430 that includes an example implementation of ADC 404, in accordance with aspects of the disclosure. Quantization logic 412 may include a comparator 432, a pixel data retention control (PDRC) cell 434, a retention switch 436, and a retention control signal 438. Pixel memory 406 may include a multiplexor 440 to write to bank 1 pixel memory 442 and may include a multiplexor 444 to write to bank 2 pixel memory 446. Pixel memory 406 may include a digital counter 448 having a number of bitlines 450 that are coupled to pixel memory 442 and 446 to provide digital values to the memory. Bitlines 450 are selectively coupled to pixel memory 442 and 446 with bank 1 switch 452 and bank 2 switch 454, according to an embodiment. Bitlines 450 may also be used to readout digital pixel values from pixel memory 442 and 446 by, for example, controller 420.

Comparator 432 can compare an analog voltage COMP_IN at node PIXEL_OUT against a threshold V_{REF} and generate a decision output V_{OUT} based on the comparison result. Comparator 432 can generate a logic 1 (e.g., HIGH output) for output V_{OUT} if voltage COMP_IN equals or exceeds V_{REF}. Comparator 432 can also generate a logical 0 (e.g., LOW output) for voltage V_{OUT} if voltage COMP_IN falls below V_{REF}. Voltage V_{OUT} can control a latch signal (e.g., an enable signal for multiplexors 440 and 444) that controls pixel memory 442 and/or 446 to store a digital value from digital counter 448.

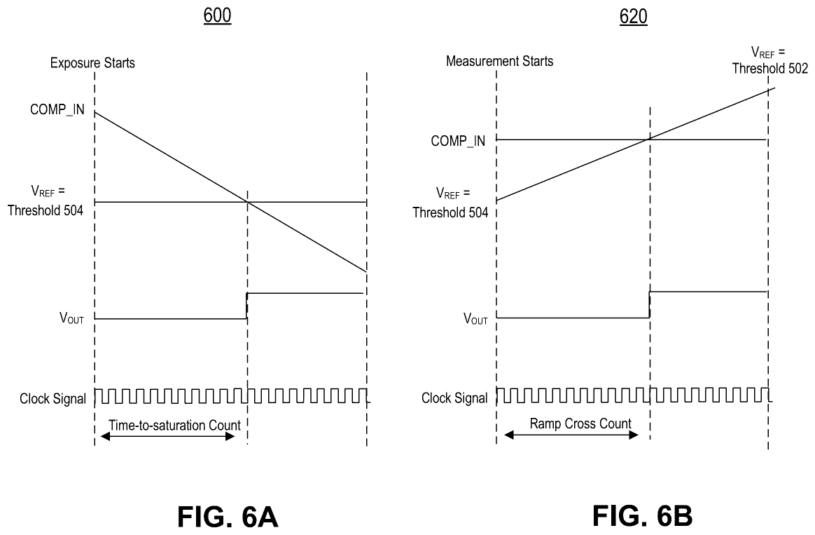

FIG. 6A illustrates a timing diagram 600 of an example of time-to-saturation measurement by ADC 404 (shown in FIGS. 4A and 4B). To perform the time-to-saturation measurement, a threshold generator (e.g., controller 420) can generate a voltage V_{REF} to be a fixed voltage. Voltage V_{REF} can be set to a voltage corresponding to a charge quantity threshold for saturation of charge storage device 408 (e.g., threshold 504 of FIG. 5). Digital counter 448 can start counting right after the exposure period starts (e.g., right after shutter switch M0 is disabled). Voltage COMP_IN is the voltage at node PIXEL_OUT. As the voltage COMP_IN ramps down (or up depending on the implementation) due to accumulation of overflow charge at charge storage device 408, the clock signal toggles to update the count value at digital counter 448. Voltage COMP_IN may reach the threshold of voltage V_{REF} at a certain time point, which causes voltage V_{OUT} to flip from LOW to HIGH. The change of voltage V_{OUT} may stop the counting of digital counter 448, and the count value at digital counter 448 may represent the time-to-saturation. The time-to-saturation value may be stored in one of banks of pixel memory 442 and 446 to enable controller 420 to read and process the determined time-to-saturation value.

FIG. 6B illustrates a timing diagram 620 of an example of measurement of a quantity of charge stored at charge storage device 408. After measurement starts, the threshold generator (e.g., controller 420) can ramp the voltage V_{REF}, which can either ramp up (in the example of FIG. 6B), ramp down, or ramp as a curved line, depending on implementation. The rate of ramping can be based on the frequency of the clock signal supplied to digital counter 448. In a case where overflow charge is measured, the ramped values of voltage V_{REF} can be between threshold 504 (charge quantity threshold for saturation of charge storage device 408) and threshold 502 (charge quantity threshold for saturation of photodiode PD), which can define the medium light intensity range. In a case where residual charge is measured, the voltage range of ramping voltage V_{REF} can be based on threshold 502 and scaled by the reduced capacity of charge storage device 408 for residual charge measurement. In the example of FIG. 6B, the quantization process can be performed with uniform quantization steps, with voltage V_{REF} increasing (or decreasing) by the same amount for each clock cycle. The amount of increase (or decrease) of voltage V_{REF} corresponds to a quantization step. When voltage V_{REF} reaches within one quantization step of the COMP_IN voltage, voltage V_{OUT} of comparator 432 flips, which can stop the counting of digital counter 448, and the count value can correspond to a total number of quantization steps accumulated to match, within one quantization step, the value of voltage COMP_IN. The count value can become a digital representation of the quantity of charge stored at charge storage device 408, as well as the digital representation of the incident light intensity.

Referring back to FIG. 4B, controller 420 can, based on selection signal 422, perform a TTS quantization operation, multiple quantization operations to measure a quantity of overflow charge (herein after, “FD ADC” operation), and multiple quantization operations to measure a quantity of residual charge (hereinafter “PD ADC” operation). The combination of the FD ADC operations and PD ADC operations enable D-CDS operations to reduce FPN while concurrently supporting triple quantization, in accordance with aspects of the disclosure. The TTS quantization operation can be based on the scheme described in FIG. 6A, and the PD ADC and FD ADC quantization operations can be based on the scheme described in FIG. 6B.

PDRC 434 and memory enable signals from controller 420 may be used to write quantized incident light values to bank 1 pixel memory 442 and bank 2 pixel memory 446, in accordance with aspects of the disclosure. PDRC 434 may receive a value of a retention control signal 438 that is coupled to PDRC 434 through retention switch 436. Responsive to the retention control signal 438, PDRC 434 provides a comparator control signal that locks or unlocks comparator 432 from updating comparator output voltage V_{OUT}. Comparator output voltage V_{OUT} operates retention switch 436 and is coupled to enable operation of multiplexors 440 and 444, according to an embodiment. When comparator output voltage V_{OUT} is HIGH (e.g., a logic 1), retention switch 436 may be closed to enable retention control signal 438 to be written to PDRC 434. When comparator output voltage V_{OUT} is HIGH (e.g., a logic 1), multiplexor 440 and 444 may have an output that depends on memory bank enable signals EN BANK 1 WL and EN BANK 2 WL. Memory bank enable signals EN BANK 1 WL and EN BANK 2 WL may be provided by controller 420, and multiplexor 440 and 444 may have outputs that operate bank 1 switch 452 and bank 2 switch 454, respectively. Bank 1 switch 452 and bank 2 switch 454 are configured to couple the memory banks to bitlines 450 of digital counter 448, according to an embodiment. By selectively locking and unlocking comparator 432, PDRC 434 operates in conjunction with comparator 432 to determine when new values may be written to bank 1 pixel memory 442 and bank 2 pixel memory 446, according to an embodiment. PDRC 434 locks both of the two banks of memories while the two banks are involved in two separate quantization operations (e.g., TTS, PD ADC, FD ADC operations). By selectively double-sampling photodiode PD and charge storage device 408 and by storing the values of the samples, controller 420 can perform D-CDS operations to reduce FPN that is not reduced using, for example, A-CDS operations, according to an embodiment.

FIG. 4C illustrates an example circuit-level implementation of PDRC 434, in accordance with aspects of the disclosure. PDRC 434 may include a number of switches M40, M41, M42, and M43 that are configured to operate as two inverters having input nodes tied together and having output nodes selectively coupled together with switch M44. Switch M44 may be configured to be operated by comparator output voltage V_{OUT}. PDRC 434 may be powered with a switch M43 that is biased by a VBP signal. PDRC 434 may include a switch M45, which may be an implementation of retention switch 436. Switch M45 may selectively couple retention control signal 438 to switches M40 and M41 in response to voltage V_{OUT}, according to an embodiment. Using switches M42 and M42, PDRC 434 may provide PDRC OUTPUT, which is a comparator control signal that selectively locks and unlocks voltage V_{OUT} of comparator 432. When comparator output voltage V_{OUT} is HIGH, the positive-feedback loop between the two inverters is cut off by the bottom PMOS switch M44 and the input is coupled to retention control signal 438 with switch M45. When voltage V_{OUT} is LOW, PDRC 434 is disconnected from retention control signal 438 by switch M45, and the two inverters formed by switches M40, M41, M42, and M43 are connected in a cross-coupled fashion to form a positive-feedback loop to sustain its state.

FIG. 4D illustrates an example of an operation table 470 for PDRC 434, in accordance with aspects of the disclosure. PDRC 434 is configured to provide functional logic for D-CDS with multiple quantization. Operation table 470 shows a truth table description of the logic function of PDRC 434. According to operation table 470, if comparator output voltage V_{OUT} stays at logic 0 (LOW), PDRC 434 will hold previous data and keep the comparator status as previous state (locked or not locked). When comparator output voltage V_{OUT} is a logic 1 (HIGH), PDRC 434 will be overwritten by retention control signal 438, which decides the next status of comparator (locked or not locked). The logic of PDRC 434 in combination with comparator 432 determines whether multiplexors 440 and 440 are enabled and partially determines whether new values may be written to banks of pixel memory 442 and 446, according to an embodiment.

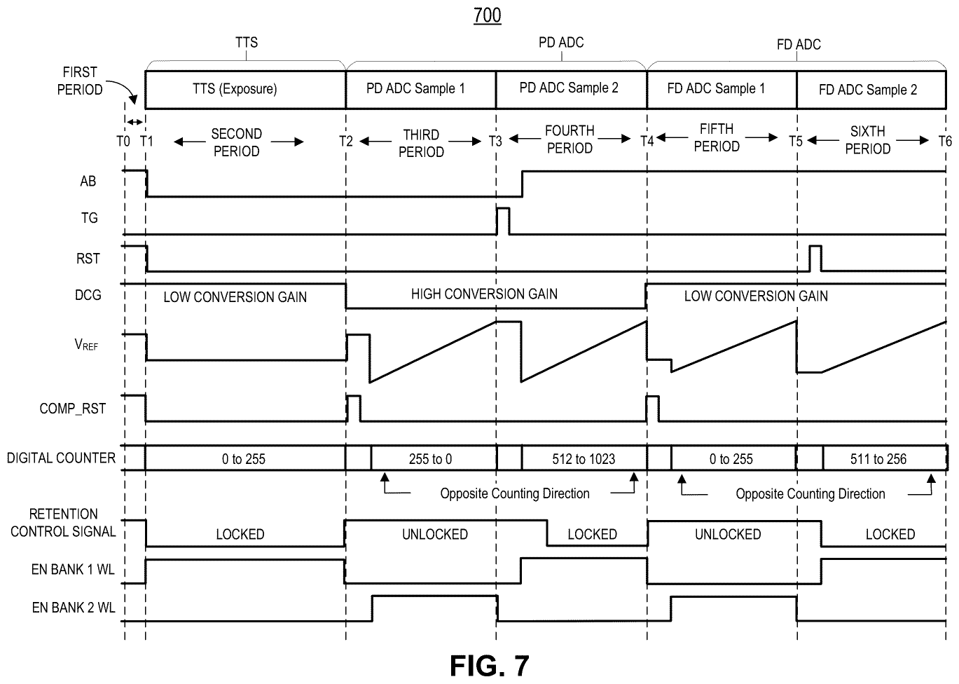

Reference is now made to FIG. 7, which illustrates an example timing diagram 700 of sequences of control signals of pixel 430 of FIG. 4B for performing D-CDS operations with triple quantization, in accordance with aspects of the disclosure. In contrast to A-CDS, which only runs an ADC operation once in each quantization mode, D-CDS runs ADC operations twice in each quantization mode, according to an embodiment. The quantization modes include TTS, PD ADC, and FD ADC modes. For each quantization mode in D-CDS, retention control signal 438 is set to LOW in one of the two ADC operations to lock the comparator if it flips, according to an embodiment. In other words, one of the two samples in each quantization mode determines whether the pixel memory becomes locked in the particular quantization mode while the other sample does not, according to an embodiment.

Timing diagram 700 includes operations for each of TTS, PD ADC, and FD ADC modes, which may be responsive to a selection signal 422. Timing diagram 700 illustrates the change of AB, TG, RST, DCG, V_{REF}, COMPARATOR RESET (COMP_RST), DIGITAL COUNTER, RETENTION CONTROL SIGNAL, EN BANK 1 WL, and EN BANK 2 WL signals with respect to time. For ease of description, timing diagram 700 is roughly divided into six periods including a first period that spans time TO to time T1, a second period that spans time T1 to time T2, a third period that spans time T2 to time T3, a fourth period that spans time T3 to time T4, a fifth period that spans time T4 to time T5, and a sixth period that spans time T5 to time T6.

During the first period (between times T0 and T1), the pixel is reset, in accordance with aspects of the disclosure. During the first period, photodiode PD, charge storage device 408, and comparator 432 can be put in a reset state by controller 420 by asserting the RST, DCG, and COMP_RST signals, and the shutter signal AB can be asserted to prevent charge from being generated by photodiode PD. Both RST and DCG signals are asserted to reset capacitors C_{FD} and C_{ENT} (charge storage device 408) and to set the voltage COMP_IN at the node PIXEL_OUT at a reset level. COMP_RST signal may be used to activate a switch (not shown) that is coupled between an output node of comparator 432 and the input node PIXEL_OUT of comparator 432 so that voltage V_{OUT} is approximately the same as voltage COMP_IN.

During the second period (between times T1 and T2), incident light intensity may be quantized in a TTS mode of operation, in accordance with aspects of the disclosure. Incident light intensity may be quantized by setting voltage V_{REF} to a value that is indicative of medium or high intensity light levels. Voltage V_{REF} is converted to a digital value if comparator 432 flips from LOW to HIGH during the TTS mode of the second period, according to an embodiment. Controller 420 also sets EN BANK 1 WL signal to HIGH to enable write operations to bank 1 pixel memory 442 to capture a digital value from digital counter 448, if incident light intensity is high enough to exceed the threshold of voltage V_{REF}, according to an embodiment. During the second time period AB is LOW, TG is LOW, RST is LOW, DCG is HIGH, COMP_RST is LOW, DIGITAL COUNTER is incremented in quantization/clocked steps from 0 to 255, and RETENTION CONTROL SIGNAL is low so that PDRC OUTPUT is HIGH to lock comparator 432. Although only one ADC operation is shown in the second period, it is possible to add one additional ADC operation before TTS to capture the FPN in TTS. Since the FPN in TTS may have signal dependency, the ramp slope used in this potentially additional ADC operation may be selected to balance the effectiveness of FPN compensation across the whole TTS signal range.

In PD ADC mode and during the third period (between times T2 and T3), a first PD ADC sample of node FD is stored in memory before the charge on photodiode PD is transferred to charge storage device 408, in accordance with aspects of the disclosure. The first PD ADC sample is taken in high conversion gain mode while DCG signal is low, which isolates capacitor C_{FD} from capacitor C_{EXT}. The charge (e.g., voltage) at node FD is converted to a digital value by ramping voltage V_{REF}. V_{REF} is converted to a digital value when comparator 432 flips from LOW to HIGH during the PD ADC mode of the third period, according to an embodiment. Controller 420 also sets EN BANK 2 WL signal to HIGH to enable write operations to bank 2 pixel memory 446 to capture a digital value from digital counter 448, according to an embodiment. RETENTION CONTROL SIGNAL is set to HIGH so comparator 432 is UNLOCKED and permitted to change values. During the third time period AB is LOW, TG is LOW, RST is LOW, DCG is LOW, COMP_RST is briefly toggled then set to LOW, DIGITAL COUNTER is decremented in quantization/clocked steps from 255 to 0, and RETENTION CONTROL SIGNAL is HIGH so that PDRC OUTPUT is LOW to unlock comparator 432.

In PD ADC mode and during the fourth period (between times T3 and T4), a second PD ADC sample of node FD is stored in memory after the charge on photodiode PD is transferred to charge storage device 408, in accordance with aspects of the disclosure. The second PD ADC sample is taken after TG signal is toggled from LOW to HIGH to LOW to transfer charge from photodiode PD to node FD. The second PD ADC sample is taken in high conversion gain mode while DCG signal is low, which isolates capacitor C_{FD} from capacitor C_{EXT}. The charge at node FD is converted to a digital value by ramping voltage V_{REF}. Voltage V_{REF} is converted to a digital value when comparator 432 flips from LOW to HIGH during the PD ADC mode of the fourth period, according to an embodiment. Controller 420 also sets EN BANK 1 WL to HIGH to enable write operations to bank 1 pixel memory 442 to capture a digital value from digital counter 448, according to an embodiment. RETENTION CONTROL SIGNAL is set to LOW so comparator 432 locks in a value. During the fourth time period, AB is changed to HIGH to reset charge levels on photodiode PD, TG is toggled and set to LOW, RST is LOW, DCG is LOW, COMP_RST is LOW, DIGITAL COUNTER is incremented from 512 to 1023, and RETENTION CONTROL SIGNAL is set to LOW so that PDRC OUTPUT is HIGH to lock comparator 432, according to an embodiment.

In FD ADC mode and during the fifth period (between times T4 and T5), a first FD ADC sample of node FD is stored in memory after the charge on node FD has been distributed between capacitors C_{FD} and C_{ENT}, in accordance with aspects of the disclosure. The first FD ADC sample is taken in low conversion gain mode while DCG signal is set HIGH, which couples capacitor C_{FD} to capacitor C_{EXT}. The charge at node FD is converted to a digital value by ramping voltage V_{REF}. Voltage V_{REF} is converted to a digital value when comparator 432 flips from LOW to HIGH during the FD ADC mode of the fifth period, according to an embodiment. Controller 420 also sets EN BANK 2 WL to HIGH to enable write operations to bank 2 pixel memory 446 to capture a digital value from digital counter 448, according to an embodiment. RETENTION CONTROL SIGNAL is set to HIGH so comparator 432 is UNLOCKED and can change values. During the fifth time period, AB is HIGH to reset photodiode PD, TG is set to LOW, RST is LOW, DCG is HIGH, COMP_RST is toggled and set to LOW to reset comparator 432, DIGITAL COUNTER is gradually increased from 0 to 255, and RETENTION CONTROL SIGNAL is set to HIGH so that PDRC OUTPUT is LOW to unlock comparator 432, according to an embodiment.

In FD ADC mode and during the sixth period (between times T5 and T6), a second FD ADC sample of node FD is stored in memory after the charge stored on capacitors C_{FD} and C_{EXT} has been reset, in accordance with aspects of the disclosure. The second FD ADC sample is taken in low conversion gain mode while DCG signal is set HIGH, which couples capacitor C_{FD} to capacitor C_{EXT}. The charge at node FD is converted to a digital value by ramping voltage V_{REF}. V_{REF} is converted to a digital value when comparator 432 flips from LOW to HIGH during the FD ADC mode of the sixth period, according to an embodiment. Controller 420 also sets EN BANK 1 WL to HIGH to enable write operations to bank 1 pixel memory 442 to capture a digital value from digital counter 448, according to an embodiment. RETENTION CONTROL SIGNAL is set to LOW so comparator 432 is LOCKED to save a particular output. During the sixth time period, AB is HIGH to keep photodiode PD reset, TG is set to LOW, RST is toggled and then set to LOW, DCG is HIGH, COMP_RST is LOW, DIGITAL COUNTER is decremented from 511 to 256, according to an embodiment.

In PD ADC mode operations, the first sample and second sample may provide different measurements or information. For example, the global offset (pedestal) can be different between samples, the ADC temporal noise can be different between samples, comparator contributed FPN may be the same between samples, kTC noise contributed by node FD reset can be the same between samples, kTC noise contributed by comparator reset may be the same between samples, overflow charge on node FD from PD may be the same, and node FD dark current induced charge may be the same between the first and second samples. Photodiode PD charge and photodiode PD dark current induced charge are examples of measurements or information that may be available by one of the two samples (e.g., by the second sample and not the first sample).

Depending on the digital counter code direction, the polarity of the information obtained from the samples can be the same or opposite. The global offset in the first sample and the second sample can be intentionally set to be different to reserve a margin to capture dark signal variation. Using first and second PD ADC samples, FPN and kTC noise can be canceled, and photodiode PD dark current induced charge can be compensated with global black level correction. Digital pixel values representing the first and second PD ADC samples may be subtracted from each other or added together to generate an FPN corrected digital pixel value that represents incident light intensity on a photodiode PD.

In FD ADC mode operations, the first sample and second sample may provide different measurements or information. For example, the global offset (pedestal) can be different between samples, the ADC temporal noise can be different between samples, comparator contributed FPN may be the same between samples, kTC noise contributed by node FD reset is likely different between samples, and kTC noise contributed by comparator reset may be the same between samples. Overflow charge on node FD from photodiode PD, node FD dark current induced charge, photodiode PD charge, and photodiode PD dark current induced charge are examples of measurements or information that may be available by one of the two samples (e.g., by the first sample and not the first sample). In FD ADC mode operations, there is an RST signal pulse between the two samples, so the sampled kTC noise contributed by RST signal and switch M3 in the first and second samples are different. Digital pixel values representing the first and second FD ADC samples may be subtracted from each other or added together to generate an FPN corrected digital pixel value that represents incident light intensity on a photodiode PD, according to an embodiment.

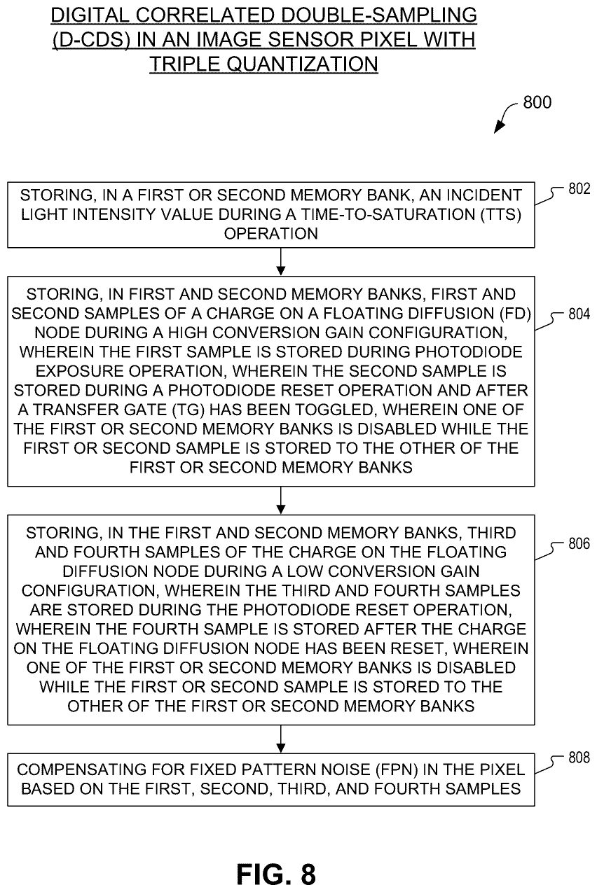

FIG. 8 illustrates an example of a process 800 for D-CDS in an image sensor pixel with triple quantization, in accordance with aspects of the disclosure. Process 800 may be at least partially incorporated into or performed by an object or eye tracking system, according to an embodiment. The order in which some or all of the process blocks appear in process 800 should not be deemed limiting. Rather, one of ordinary skill in the art having the benefit of the present disclosure will understand that some of the process blocks may be executed in a variety of orders not illustrated, or even in parallel.

At process block 802, process 800 includes storing, in a first or second memory bank, an incident light intensity value during a time-to-saturation (TTS) operation, according to an embodiment. Process block 802 proceeds to process block 804, according to an embodiment.

At process block 804, process 800 includes storing, in first and second memory banks, first and second samples of a charge on a floating diffusion (FD) node during a high conversion gain configuration, wherein the first sample is stored during photodiode exposure operation, wherein the second sample is stored during a photodiode reset operation and after a transfer gate (TG) has been toggled, wherein one of the first or second memory banks is disabled while the first or second sample is stored to the other of the first or second memory banks, according to an embodiment. Toggling the transfer gate between LOW, HIGH, and LOW states transfers charge from photodiode PD to FD node. Process block 804 proceeds to process block 806, according to an embodiment.

At process block 806, process 800 includes storing, in the first and second memory banks, third and fourth samples of the charge on the floating diffusion node during a low conversion gain configuration, wherein the third and fourth samples are stored during the photodiode reset operation, wherein the fourth sample is stored after the charge on the floating diffusion node has been reset, wherein one of the first or second memory banks is disabled while the first or second sample is stored to the other of the first or second memory banks. The floating diffusion node may be reset by toggling RST signal that operates a switch M3 (shown in FIG. 4B). Process block 806 proceeds to process block 808, according to an embodiment.

At process block 808, process 800 includes compensating for fixed pattern noise (FPN) in the pixel based on the first, second, third, and fourth samples. A controller may compensate for FPN by subtracting the value of the second sample from the first sample, which are collected during the PD ADC mode operations. The controller may compensate for FPN by subtracting the value of the fourth sample from the third sample during the FD ADC mode operations. FPN can come from comparator input offset and from comparator propagation delay variation across a digital pixel array. While analog CDS can help reduce the FPN contributed by comparator input offset through auto-zeroing, the D-CDS operations of the present disclosure may be used to reduce the FPN induced by comparator propagation delay variation across the digital pixel array, in accordance with various aspects of the disclosure.

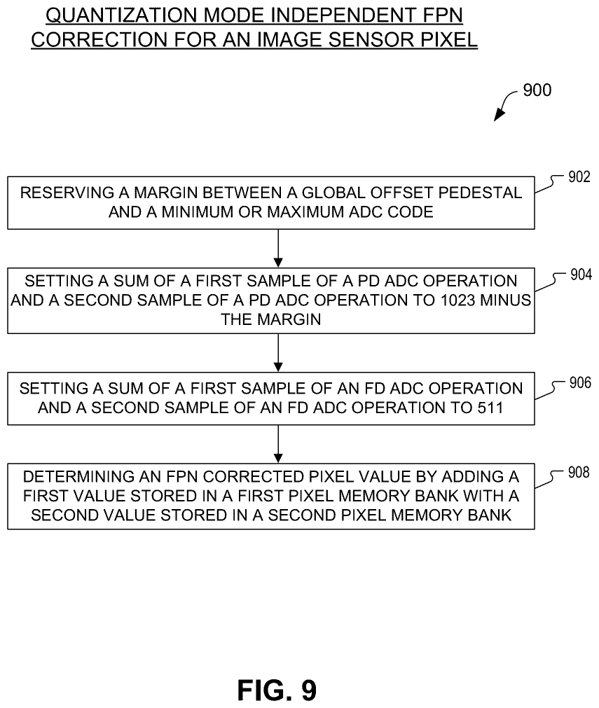

FIG. 9 illustrates an example of a process 900 for quantization mode independent FPN correction for an image sensor pixel, in accordance with aspects of the disclosure. For each pixel, the FPN in different ADC quantization modes can be different. With the pixel structure disclosed herein, an ADC setting and code direction arrangement can enable quantization mode independent FPN correction in post-processing for D-CDS based multiple quantization. When setting the nominal global offset (or pedestal) of an ADC operation in an image sensor, a margin may be reserved between the pedestal and the minimum ADC code or the maximum ADC code. This is because the dark level can vary spatially inside the pixel array or temporarily across different frames due to noise. By reserving a margin, the dark variation can be captured in sensor raw data to allow black level correction in post-processing. The order in which some or all of the process blocks appear in process 900 should not be deemed limiting. Rather, one of ordinary skill in the art having the benefit of the present disclosure will understand that some of the process blocks may be executed in a variety of orders not illustrated, or even in parallel.

At process block 902, process 900 includes reserving a margin between a global offset pedestal and a minimum or maximum ADC code, according to an embodiment. Process block 902 proceeds to process block 904, according to an embodiment.

At process block 904, process 900 includes setting a sum of a first sample of a PD ADC operation and a second sample of a PD ADC operation to 1023 minus the margin, according to an embodiment. For PD ADC mode operation, a margin may be advantageous because the dark level will be captured in PD ADC operation. The sum of the first and second sample of a PD ADC operation may be written as Equation 1.

$$Sample 1 ADC pedestal + Sample 2 ADC pedestal = 1023 - Margin \qquad Equation 1$$

### Process Block 904 Proceeds to Process Block 906, According to an Embodiment.

At process block 906, process 900 includes setting a sum of a first sample of an FD ADC operation and a second sample of an FD ADC operation to 511, according to an embodiment. For FD ADC mode operations, margin may be omitted because dark level is not captured in FD ADC mode operations. The sum of the first and second samples of FD ADC operations may be written as Equation 2.

$$Sample 1 ADC pedestal + Sample 2 ADC pedestal = 511 \qquad Equation 2$$

### Process Block 906 Proceeds to Process Block 908, According to an Embodiment.

At process block 908, process 900 includes determining an FPN corrected pixel value by adding a first value stored in a first pixel memory bank with a second value stored in a second pixel memory bank, according to an embodiment. FPN correction may be expressed as Equation 3.

$$FPN corrected pixel value - Pixel memory bank 1 + Pixel memory bank 2 \qquad Equation 3$$

The Code Range of PD ADC Sample 1 and FD ADC Sample 1 can be Smaller than 8 Bits if the Actual FPN Range is Smaller than 8 Bits.

Example numbers may be used to further illustrate process 900. If a margin of 5 is selected and PD ADC Sample 1 pedestal is 64 LSB (least significant bits), then PD ADC Sample 2 pedestal becomes (1023-64-5) 954 LSB, in accordance with Equation 1. If a PD signal charge corresponds to 12 LSB and FPN is 10 LSB, then PD ADC Sample 1 stored in Bank 1 Pixel Memory may have a value of (64-10) 54 with FPN applied. Additionally, PD ADC Sample 2 stored in Bank 2 Pixel Memory may have a value of (954-12+10) 952 with FPN and PD signal charge applied. Accordingly, an FPN corrected pixel value may be 1006, which is the sum of the two memory banks, as an example.

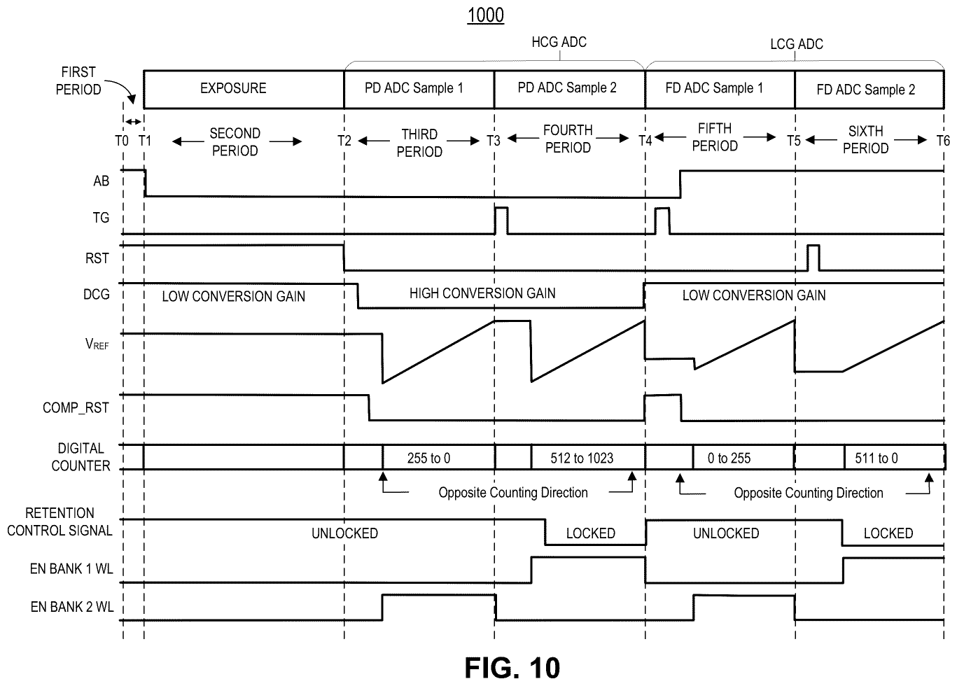

FIG. 10 illustrates a timing diagram 1000 that includes an example sequence of control signals that can be generated (e.g., by controller 420) to perform high dynamic range (HDR) operations that include multiple quantization of incident light values for a pixel (e.g., pixel 430), in accordance with aspects of the disclosure. In dual conversion gain HDR, two charge transfers from photodiode PD are used for each capture. The first charge transfer (e.g., by operating transfer switch M1) happens when node FD is set in high conversion gain mode by decoupling capacitor C_{EXT} from node FD. Because node FD may be implemented with a relatively small full well capacity (FWC), the charge transfer may not be complete when photodiode PD charge exceeds the FWC of node FD. In such a situation, a second charge transfer can be used to transfer more charge from photodiode PD to node FD after node FD is coupled to capacitor C_{EXT} to expand the FWC of node FD.

Timing diagram 1000 show a sequence that is similar to the sequence of timing diagram 700, according to an embodiment. Timing diagram 1000 includes a high conversion gain (HCG) ADC mode operation and a low conversion gain (LCG) mode operation. DCG signal is operated to set charge storage device 408 in HCG mode during HCG ADC mode operation and is operated to set charge storage device 408 in LCG mode during LCG ADC mode operation, according to an embodiment. TG signal is toggled a first time during the second PD ADC sample during the fourth period. TG signal is toggled a second time during the first FD ADC sample during the fifth period. Memory banks are alternately enabled and RETENTION CONTROL SIGNAL causes a comparator to be unlocked during the first PD ADC and first FD ADC samples.

Charge overflow to node FD may disturb the signal on node FD. To avoid this disruption, AB signal and TG signal are configured to direct photodiode PD charge overflow to go through switch M0 (e.g., the shutter switch) to be drained instead of overflowing to node FD. This is different from the triple quantization scheme (e.g., of timing diagram 700) which directs overflow charge to node FD.

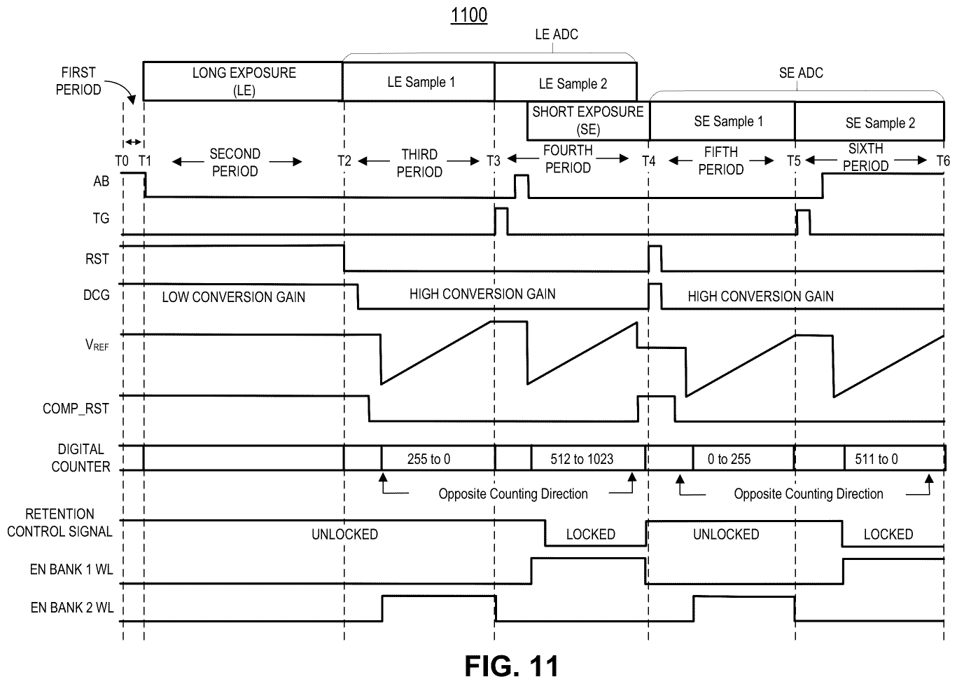

FIG. 11 illustrates a timing diagram 1100 that includes an example sequence of control signals that can be generated by controller 420 to perform multiple exposure HDR operations for a pixel (e.g., pixel 430), in accordance with aspects of the disclosure. Multiple exposure is an established technique for HDR imaging. Timing diagram 1100 is an example timing diagram with two exposure windows that include a long exposure (LE) window and a short exposure (SE) window. More than two exposure windows can also be supported with modified pixel driving signals and additional ADC operations. During the LE ADC mode operation, a first LE sample is written to a first memory bank (e.g., using EN BANK 2 WL signal) and a second LE sample is written to a second memory bank (e.g., using EN BANK 1 WL signal). During the first and second LE ADC samples, DCG signal is set to LOW to operate the pixel in high conversion gain mode. During the SE ADC mode operation, a first SE sample is written to a first memory bank (e.g., using EN BANK 2 WL signal) and a second SE sample is written to a second memory bank (e.g., using EN BANK 1 WL signal). During the first and second SE ADC samples, DCG signal is set to LOW to operate the pixel in HCG mode.

Several signals may be operated between the long exposure and the short exposure operations to support short exposure pixel operations. For example, during the fourth period, AB signal may operate a shutter switch to reset charge on photodiode PD after charge is transferred from photodiode PD to node FD (e.g., using the TG signal). Additionally, during the fifth period and for the first SE sample, RST signal and DCG signal may be briefly toggled from LOW to HIGH to LOW to reset the charge on node FD. The comparator may be reset by toggling COMP_RST signal between LE ADC mode operations and SE ADC mode operations. RETENTION CONTROL SIGNAL may be operated in combination with EN BANK 1 WL and EN BANK 2 WL signals to selectively enable storing digital values to banks of pixel memory.

Charge overflow to node FD may disturb the signal on node FD. To avoid this disruption, AB signal and TG signal are configured to direct photodiode PD charge overflow to go through transistor M0 (e.g., the shutter switch) to be drained instead of overflowing to node FD. This is different from the triple quantization scheme (e.g., of timing diagram 700) which directs overflow charge to node FD.

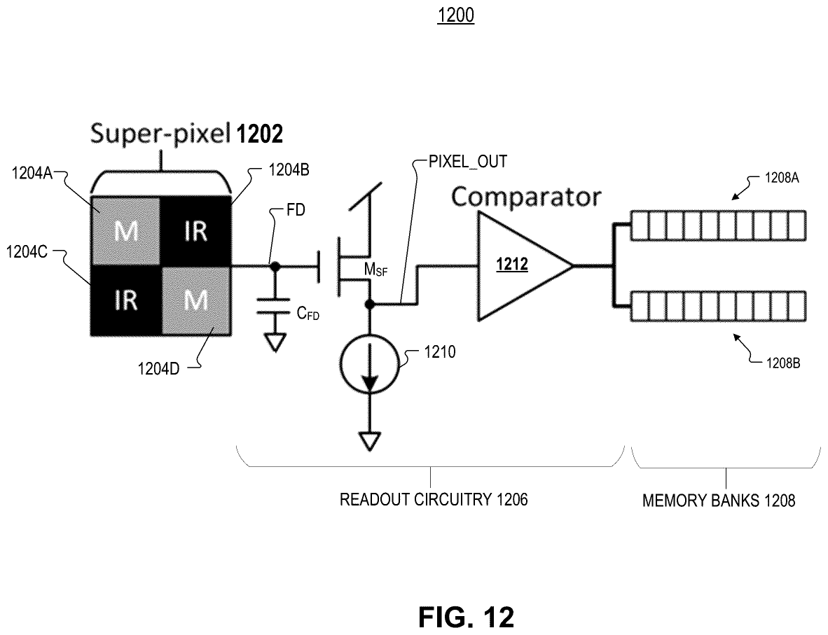

FIG. 12 illustrates an example diagram of a pixel 1200 having a superpixel structure configured to provide dual-channel imaging, in accordance with aspects of the disclosure. A challenge with multi-channel image sensors is the spatial co-location of the captured images from two channels. Some multi-channel image sensors are implemented with the sensing layers of the two channels vertically stacked, but vertically stacking channels can be difficult to implement. When the imaging areas of two channels in a multi-channel image sensor are not physically co-located, improving the pixel-level co-location can be a challenge. To resolve issues related to pixel-level co-location, pixel 1200 includes a superpixel 1202 having four different subpixels 1204 coupled to shared readout circuitry 1206 and memory banks 1208, in accordance with aspects of the disclosure.

Superpixel 1202 include subpixels 1204 positioned in a particular pattern according to an embodiment. Subpixels 1204 include a subpixel 1204A, a subpixel 1204B, a subpixel 1204C, and a subpixel 1204D. Subpixel 1204A and subpixel 1204D may be configured to have a transparent color filter array (CFA), so that monochromatic (e.g., inclusive of visible and NIR bands) light is passed onto photodiodes of subpixels 1204A and 1204D. Subpixels 1204A and 1204D are positioned diagonally to each other, and superpixel 1202 includes four subpixels 1204 arranged into a 2×2 array, according to an embodiment. Subpixels 1204B and 1204C each have a CFA that is configured to pass near infrared (NIR) light and filter out other wavelengths of light, according to an embodiment. Subpixels 1204B and 1204C may include a near-infrared bandpass filter disposed over respective photodiodes of the subpixels, and the bandpass filter may pass a bandwidth of less than 50 nm. Subpixels 1204B and 1204C are positioned in superpixel 1202 diagonally from each other, according to an embodiment. As a result of the positioning of subpixels 1204, two channels of wavelengths may be read from superpixel 1202 with imaging data that is co-located at a pixel level.

Readout circuitry 1206 may include a node FD, a source follower MsF, a current source 1210, and a comparator 1212, according to an embodiment. Node FD may have a capacitance C_{FD} and may be coupled to a gate of source follower MsF, according to an embodiment. Current source 1210 is coupled to source follower MsF and is configured to bias source follower MsF, according to an embodiment. Node PIXEL_OUT may couple source follower MsF to comparator 1212, and comparator 1212 is configured to convert the charge at node FD into digital values stored in memory banks 1208, according to an embodiment. Memory banks 1208 may include a memory bank 1208A and a memory bank 1208B. A first of memory banks 1208 (e.g., memory bank 1208A) may be configured to store digital values of incident light from one channel (e.g., monochromatic light), and a second of memory banks 1208 (e.g., memory bank 1208B) may be configured to store digital values of incident light from another channel (e.g., NIR light), according to an embodiment.

Each of subpixels 1204 may be assigned to one of two channels. The two channels may be a monochrome (M) channel and near-infrared (NIR) channel. Memory banks 1208 may be configured to allow capturing and storing signals from both channels concurrently. The readout circuitry 1206 may be shared by the two channels to reduce pixel area. If pixel 1200 is implemented in a two-layer 3D stacking process with pixel-wise hybrid-bonding, the pixel can be partitioned at the node PIXEL_OUT, according to an embodiment. The two subpixels in the same channel can be read out in binning mode. This diagonal arrangement may produce an improved co-location effect between the two channels when compared to other types of arrangements.

Clear filters on top of monochromatic channel subpixels may improve overall NIR sensitivity. The optical response difference between the two channels is from the different types of pixel level filters. For the monochromatic channel, the filter is clear—having no filtering effect. Therefore, the monochromatic channel operates as an “M+NIR” channel as it captures both visible and NIR light. The NIR pass filter on top of NIR subpixels can filter out visible light while letting NIR light pass through. Accordingly, the whole area of superpixel 1202 may be sensitive to NIR light. The NIR pass filter may be configured to filter out the undesired light wavelength range up to 700 nm. If the end application benefits from a narrow band in NIR range, a dual-bandpass filter at the lens level may be used to filter out the undesired NIR light.

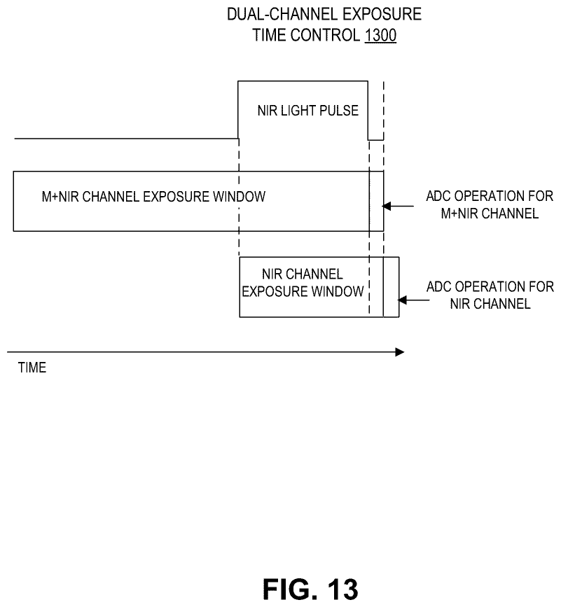

FIG. 13 illustrates an example diagram 1300 of dual-channel exposure time control, in accordance with aspects of the disclosure. Using techniques similar to those of timing diagram 700, timing diagram 1000, and/or timing diagram 1100, the exposure time control for two channels (e.g., M and NIR) can be independently controlled. Using, for example, an implementation of the long exposure and short exposure scheme of timing diagram 1100, the exposure time of the M channel can be optimized for sensing ambient light while the exposure time of the NIR channel can be aligned with the NIR light pulse from an NIR projector in an AR/VR system. This flexibility in a dual-channel sensor may improve system performance and power efficiency over a single-channel sensor solution for sensing both visible and NIR light. For example, if the NIR light pulse is shorted to save power, NIR channel exposure window can be reduced as well to align with NIR light pulse width to maintain NIR signal to ambient signal ratio, while the monochromatic channel exposure window can be preserved.

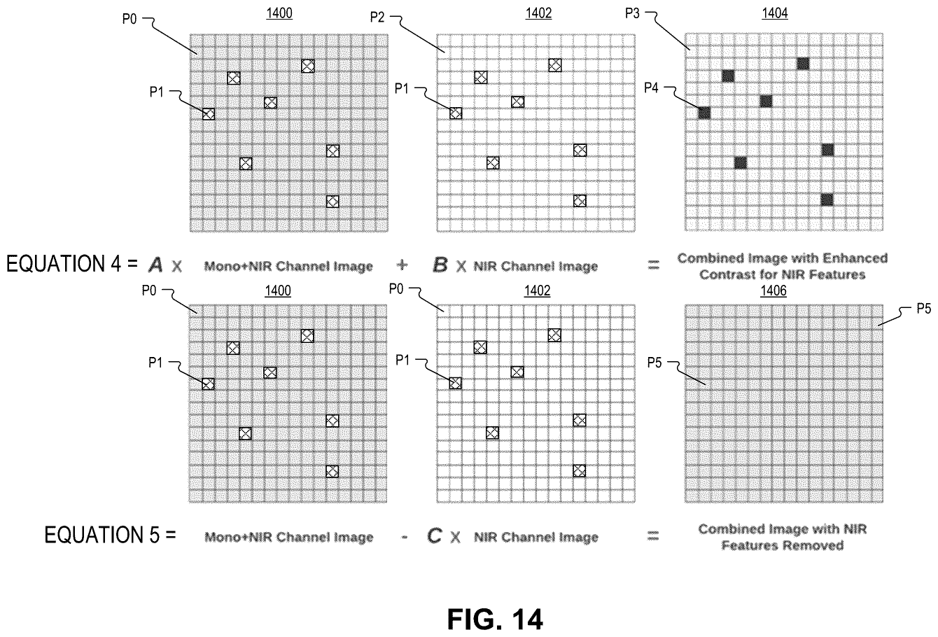

FIG. 14 illustrates an example diagram of enhanced and removed NIR features for pixel maps from multi-channel pixels, in accordance with aspects of the disclosure. An advantage of a dual-channel image sensor is that the information enables operations on the captured two-channel images to achieve improved contrast between the two channels of signals. A pixel map 1400 includes an M+NIR channel image data that is made up of a number of pixel values P0 that represent the capture of monochromatic image data without NIR image data. Pixel map 1400 includes a number of pixel values P1 (illustrates with cross hatching) that include captured NIR image data with monochromatic image data. A pixel map 1402 includes a number of pixel values P2 that could represent NIR channel image data. Pixel map 1402 includes the number of pixels P1 that include captured NIR image data. Pixel map 1404 includes a number of pixel values P3 that represent weighted and suppressed monochromatic image data. Pixel map 1404 includes a number of pixel values P4 that represent weighted and enhanced NIR image data. Pixel values may be weighted to be suppressed or enhanced using Equation 4.

$$A \times ( M + NIR Pixel Values ) + B \times ( NIR Pixel Values ) = NIR Enhanced M + NIR Pixel Values , \qquad Equation 4$$

where A is a weight that may be less than 1, and B is a weight that may be greater than 1 to enhance the contrast of NIR image data in a pixel map.

Pixel map 1406 includes a number of pixel values P5 that represent weighted and suppressed NIR image data. NIR pixel values may be weighted to be suppressed using Equation 5.

$$( M + NIR Pixel Values ) - C \times ( NIR Pixel Values ) = NIR Suppressed m + NIR Pixel Values , \qquad Equation 5$$

where C is a weight that may be set to a coefficient that is equal to the sensitivity ratio between the two channels to enhance the suppression of NIR image data in pixel map 1406.

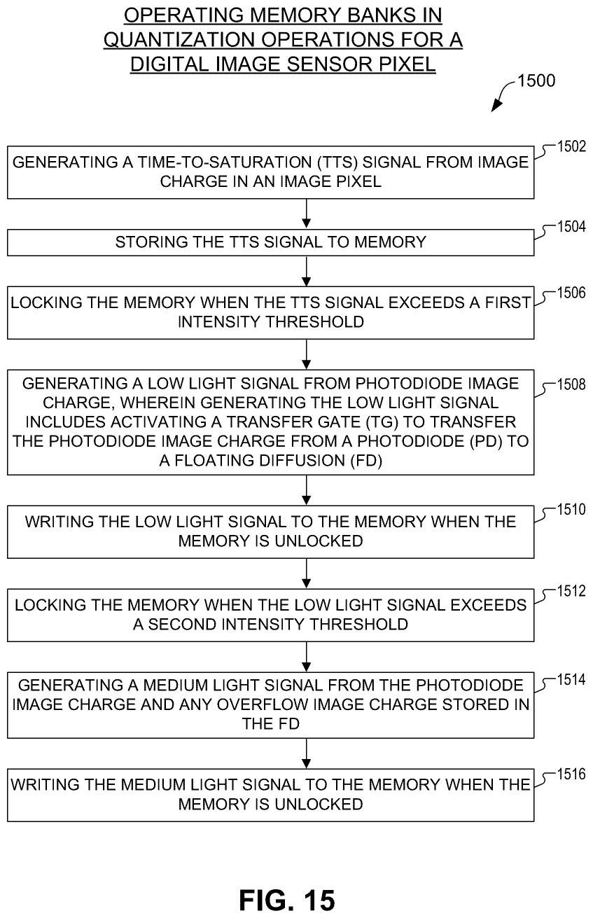

FIG. 15 illustrates an example of a process 1500 for operating memory banks in quantization operations for a digital image sensor pixel, in accordance with aspects of the disclosure. The order in which some or all of the process blocks appear in process 1500 should not be deemed limiting. Rather, one of ordinary skill in the art having the benefit of the present disclosure will understand that some of the process blocks may be executed in a variety of orders not illustrated, or even in parallel.

At process block 1502, process 1500 includes generating a Time-to-Saturation (TTS) signal from image charge in an image pixel, according to an embodiment. Process block 1502 proceeds to process block 1504, according to an embodiment.

At process block 1504, process 1500 includes storing the TTS signal to memory, according to an embodiment. Process block 1504 proceeds to process block 1506, according to an embodiment.

At process block 1506, process 1500 includes locking the memory when the TTS signal exceeds a first intensity threshold, according to an embodiment. Process block 1506 proceeds to process block 1508, according to an embodiment.

At process block 1508, process 1500 includes generating a low light signal from photodiode image charge, wherein generating the low light signal includes activating a transfer gate (TG) to transfer the photodiode image charge from a photodiode (PD) to a floating diffusion (FD), according to an embodiment. Process block 1508 proceeds to process block 1510, according to an embodiment.

At process block 1510, process 1500 includes writing the low light signal to the memory when the memory is unlocked, according to an embodiment. Process block 1510 proceeds to process block 1512, according to an embodiment.

At process block 1512, process 1500 includes locking the memory when the low light signal exceeds a second intensity threshold, according to an embodiment. Process block 1512 proceeds to process block 1514, according to an embodiment.

At process block 1514, process 1500 includes generating a medium light signal from the photodiode image charge and any overflow image charge stored in the FD, according to an embodiment. Process block 1514 proceeds to process block 1516, according to an embodiment.

At process block 1516, process 1500 includes writing the medium light signal to the memory when the memory is unlocked, according to an embodiment.

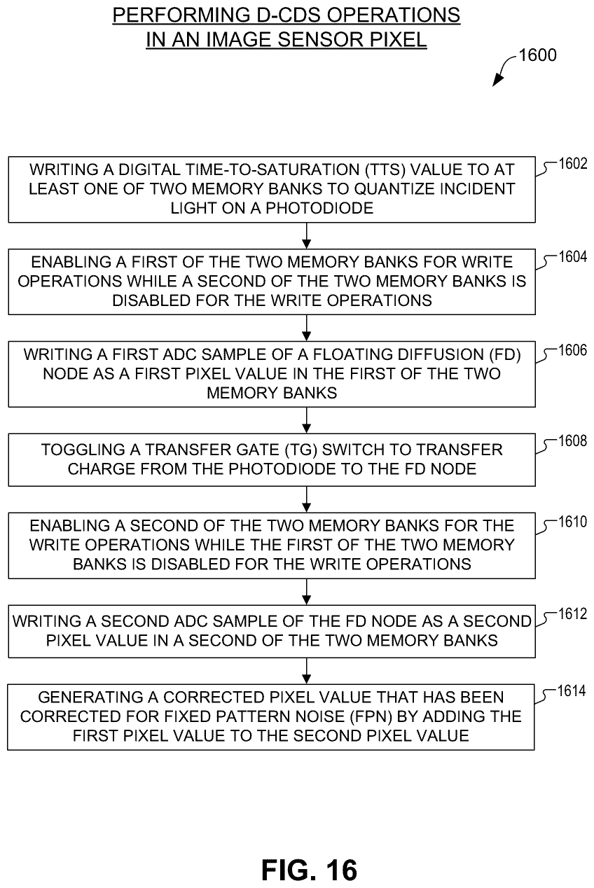

FIG. 16 illustrates an example of a process 1600 for performing D-CDS operations in an image sensor pixel, in accordance with aspects of the disclosure. The order in which some or all of the process blocks appear in process 1600 should not be deemed limiting. Rather, one of ordinary skill in the art having the benefit of the present disclosure will understand that some of the process blocks may be executed in a variety of orders not illustrated, or even in parallel.

At process block 1602, process 1600 includes writing a digital Time-to-Saturation (TTS) value to at least one of two memory banks to quantize incident light on a photodiode, according to an embodiment. Process block 1602 proceeds to process block 1604, according to an embodiment.

At process block 1604, process 1600 includes enabling a first of the two memory banks for write operations while a second of the two memory banks is disabled for the write operations, according to an embodiment. Process block 1604 proceeds to process block 1606, according to an embodiment.

At process block 1606, process 1600 includes writing a first ADC sample of a floating diffusion (FD) node as a first pixel value in the first of the two memory banks, according to an embodiment. Process block 1606 proceeds to process block 1608, according to an embodiment.

At process block 1608, process 1600 includes toggling a transfer gate (TG) switch to transfer charge from the photodiode to the FD node, according to an embodiment. Process block 1608 proceeds to process block 1610, according to an embodiment.

At process block 1610, process 1600 includes enabling a second of the two memory banks for the write operations while the first of the two memory banks is disabled for the write operations, according to an embodiment. Process block 1610 proceeds to process block 1612, according to an embodiment.

At process block 1612, process 1600 includes writing a second ADC sample of the FD node as a second pixel value in a second of the two memory banks, according to an embodiment. Process block 1612 proceeds to process block 1614, according to an embodiment.

At process block 1614, process 1600 includes generating a corrected pixel value that has been corrected for fixed pattern noise (FPN) by adding the first pixel value to the second pixel value, according to an embodiment.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., 146, 162) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., 148 and/or 164) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of performing double-correlated digital sampling (D-CDS) operations in an image sensor pixel, comprising:
writing a digital Time-to-Saturation (TTS) value to at least one of two memory banks to quantize incident light on one or more photodiodes in the image sensor pixel;
enabling a first of the two memory banks for write operations while a second of the two memory banks is disabled for the write operations;
writing a first ADC sample of a floating diffusion (FD) node as a first digital value in the first of the two memory banks;
toggling a transfer gate (TG) switch to transfer charge from the photodiode to the FD node;
enabling a second of the two memory banks for the write operations while the first of the two memory banks is disabled for the write operations;
writing a second ADC sample of the FD node as a second digital value in a second of the two memory banks; and
generating a corrected pixel value that has been corrected for fixed pattern noise (FPN) by adding the first digital value to the second digital value.

2. The method of claim 1 further comprising:
selectively locking output from a comparator with data retention logic to selectively enable write operations to the two memory banks.

3. The method of claim 1, wherein a sum of the first pixel value and the second pixel value are set to 1023 minus a margin, wherein the margin is a digital value between a nominal global offset and a minimum value or maximum value of an ADC.

4. The method of claim 1, wherein a sum of the first pixel value and the second pixel value are set to 511.

5. The method of claim 1 further comprising:
operating a digital counter in a first counting direction for the first ADC sample; and
operating the digital counter in a second counting direction for the second ADC sample, wherein the first counting direction and the second counting direction are opposite counting directions.

6. The method of claim 1, wherein the one or more photodiodes include a first photodiode, a second photodiode, a third photodiode, and a fourth photodiode oriented in a 2×2 array, wherein the first photodiode is positioned diagonally to the third photodiode in the 2×2 array, wherein the second photodiode is positioned diagonally to the fourth photodiode in the 2×2 array, wherein the wherein the first photodiode and the third photodiode are configured to generate monochromatic image data, wherein the monochromatic image data includes visible light data and near-infrared (NIR) light data, wherein the second photodiode and the fourth photodiode are configured to generate near-infrared (NIR) image data.

7. The method of claim 6 further comprising:
weighting the NIR image data with a multiplier;
adding the NIR image data to the monochromatic image data to increase a contrast of the NIR image data within a combination of the monochromatic image and the NIR image data; and
subtracting the NIR image data from the monochromatic image data to decrease the contrast of the NIR image data within the combination of the monochromatic image and the NIR image data.

8. The method of claim 1 further comprising:
resetting a charge on the photodiode with a shutter switch during a sampling period of the second ADC sample.

9. The method of claim 1, wherein the FD node is decoupled from a charge extension capacitor (C_{EXT}) while writing the first and second ADC samples of the FD node to the two memory banks.

10. An image pixel comprising:
a first subpixel configured to generate a first image signal;
a second subpixel configured to generate a second image signal, wherein the first subpixel and the second subpixel are configured to receive infrared light and reject visible light;
a third subpixel configured to generate a third image signal;
a fourth subpixel configured to generate a fourth image signal, wherein the third subpixel and the fourth subpixel are configured to receive the infrared light and the visible light; and
processing logic configured to:
generate a first readout measurement from combining the first image signal and the second image signal;
storing the first readout measurement to a first memory location;
generate a second readout measurement from combining the third image signal and the fourth image signal; and
storing the second readout measurement to a second memory location.

11. The image pixel of claim 10, wherein the first memory location and the second memory location are disposed within the image pixel.

12. The image pixel of claim 10, wherein the first subpixel, the second subpixel, the third subpixel, and the fourth subpixel are arranged in a checkerboard pattern where the first subpixel is diagonally located from the second subpixel and the third subpixel is diagonally located from the fourth subpixel.

13. The image pixel of claim 12, wherein the first subpixel, second subpixel, third subpixel, and fourth subpixel are a superpixel, wherein the superpixel is one of a plurality of superpixels positioned in a two-dimensional pixel array of an image sensor.

14. The image pixel of claim 10 further comprising:
a source follower (SF) configured to amplify the first image signal combined with the second image signal, wherein the SF is also configured to amplify the third image signal combined with the fourth image signal.

15. The image pixel of claim 10 further comprising:
a comparator coupled between the SF and the first memory location and the second memory location.

16. The image pixel of claim 10 further comprising:
a first microlens disposed over the first subpixel;
a second microlens disposed over the second subpixel;
a third microlens disposed over the third subpixel; and
a fourth microlens disposed over the fourth subpixel.

17. The image pixel of claim 10, wherein the first image signal and the second image signal are generated during a first exposure time, and wherein the third image signal and the fourth image signal are generated during a second exposure time.

18. The image pixel of claim 17, wherein the first exposure time overlaps the second exposure time.

19. The image pixel of claim 17, wherein the first subpixel is driven with a first driving signal, wherein the second subpixel is driven with a second driving signal, wherein the third subpixel is driven with a third driving signal, and wherein the fourth subpixel is driven with a fourth driving signal.

20. The image pixel of claim 10 further comprising:
a near-infrared bandpass filter disposed over the first subpixel and the second subpixel, wherein the bandpass filter passes a bandwidth of less than 50 nm.
